(19) United States
(12) Patent Application Publication
(10) Pub. No.: US 2020/0196140 A1
(43) Pub. Date: Jun. 18, 2020

(54) MINIMAL- INFRASTRUCTURE SECURE WIRELESS NETWORK AND THEREOF

(71) Applicant: Eliezer A SHEFFER, Petah Tikva (IL)

(72) Inventor: Eliezer A SHEFFER, Petah Tikva (IL)

(21) Appl. No.: 16/798,523

(22) Filed: Feb. 24, 2020

Related U.S. Application Data
(63) Continuation-in-part of application No. PCT/IL2018/050928, filed on Aug. 22, 2018.
(60) Provisional application No. 62/605,641, filed on Aug. 22, 2017.

(51) Int. Cl. H04W 12/00; H04B 1/713; H04W 4/80; H04W 24/08

(52) U.S. Cl. CPC H04W 12/0013; H04W 24/08; H04W 4/80; H04B 1/713

(57) ABSTRACT

The present invention is based on remote communication devices, called “clips,” connected directly to sensors/actuators or other digital/analog input/output. Clips are connected wirelessly to a cloud server, providing worldwide impenetrable public access-monitoring and remote control network, to any member that is a registered clip unit. A clip may be connected to either sensor or actuator, or digital/analog input/output. A traffic monitoring implementation of a mobile wireless network of the invention is further disclosed.

### CROSS REFERENCE TO RELATED APPLICATIONS

This application is a continuation-in-part of PCT/IL2018/050928 filed Aug. 22, 2018, which claims the benefit of priority of US 62/605,641 filed Aug. 22, 2017. The content of both applications are incorporated by reference in their entirety into this application.

### FIELD OF THE INVENTION

The invention is in the field of wireless computer networks, and in particular those with secure communication built into their wireless communication protocol.

### SUMMARY OF THE INVENTION

The Summary provides a non-limiting overview of some features of the invention, in various embodiments.

The invention relates to a wireless network, such as one interconnected via an IoT protocol.

In some embodiments, the invention employs little or no network infrastructure—in some embodiments, wherever the network is deployed globally.

In some embodiments, a network of the invention is based on remote units called “clips,”, connected directly to sensors/actuators or other digital/analog input/output, stationary or mobile, connected wirelessly to a cloud server (the “cloud”). In some embodiments, the network provides worldwide impenetrable public access-monitoring and a remote control network, to any “member” that is a registered clip unit. (A clip may be connected to either a sensor or actuator, or digital/analog input/output).

In some embodiments, a network of the invention is scalable, enabling flexibility engineering to optimize the size, cost, design and performance of clip devices, and their interfaces with other clip devices around it, as well as the cloud server(s) controlling/monitoring them.

The invention can provide or service networking applications, such as in the industrial, commercial, security, financial and military applications of critical infrastructure nature. In some embodiments, the invention can provide or service mobile applications such as vehicular traffic management, automatic parking, optimal control of traffic lights. In some embodiments, the invention requires little or no communication infrastructure, yet can collect real-time data from stationary and/or mobile nodes, process the data with an optimized algorithm, and report the optimized results back to the destination nodes, after the server algorithm is invoked to determine the destination nodes. In some of its embodiments, the invention provides reliable and frequent, periodical monitoring, managing, security, and data protection.

In some embodiments, the only equipment needed is a clip connected to customer devices (i.e. sensors/actuators or digital/analog input /output) connected to a free-spectrum channels transceiver , a Wi-Fi router generally found at facilities, and/or a Bluetooth transceiver (BLE). Optionally, cellular communications via a cellular or satellite transceiver may be mounted within the clip device, or may replace at least part of the need for the BLE or free spectrum transceiver.

In some embodiments, a method of the network comprises the following steps:
1. A company trains either an integrator and/or end-user customer (enterprise, or otherwise) in the operations and steps needed to get the platform ready for commercial operation. p1 2. An integrator and/or end-user of enterprise systems installs sensors/actuators, Digital/analog input/output, PLCs or mobile/smart phone/computer to clips equipped with various types of interfaces. (Serial, parallel, data, analog levels, digital, a free-spectrum transceiver, BLE, WiFi, etc.)
3. To register a new clip as a member of the platform, the end-user customer use a smart phone, with a special installed application, in order to initialize each clip in a premise (in a stationary embodiment) or mobile area or space (in a mobile embodiment) of its planned application (An application contains “members”, “spaces” and/or “premises”, where unlimited number of members are included in various premises, and various premises may be included in unlimited number of spaces. This registration process is a one-shot step and it may be updated from time to time to remove/add clips.
In some embodiments, the registration process includes:
   a. Testing of the clip/cloud wireless linkage robustness
   b. Inserting clip and device unique parameters in the cloud database for later verification and/or retrieval/storage of data.
4. The end-user customer defines the functionality of the specific application, by using simple “PowerPoint-like” program or script (called a “matrix”) defining connectivity and conditions between the sensors, sluices, switches, actuators and PLCs, needed for the proper functionality of the application. This program defines a map of TOT nodes or moving vehicles (in moving vehicle applications, a driver's own mobile phone may be used as well to communicate with the clip, and the matrix is replaced by an algorithm to route vehicle locations and other parameters to the cloud). The matrix map may be modified at any time by hierarchical levels of certified persons, verified, perhaps, by biometric means or codes.

In some embodiments, a network platform of the invention monitors and controls stationary or mobile clip device connected, for example, to a standard mains electrical receptacles or to a DC battery at one end (e.g., rechargeable and used as a back-up to the electrical supply).

In some embodiments, each clip device includes up to three (3) communication layers; for example, Bluetooth for short-range (100 meters), DSSS for mid-range (1.2-1.5Km) and Wi-Fi to connect with the local WiFi and/or BLE interface transceiver to connect with a mobile phone in a vehicle, connected to the cloud, or a cellular modem/satellite transceiver in a mobile and/or global situation (instead of the BLE interface), directly to the cloud.

In some embodiments, the platform is based on the following elements:
1. A remote subscriber unit (“clip”) comprising
   a. a short-range Bluetooth transceiver (typically 100 mW), typically used in stationary applications;
   b. a mid-range transceiver, typically a free-spectrum transceiver such as a DSSS transceiver (up to 1W);
   c. a Wi-Fi interface connecting to a local Wi-Fi router, or a BLE interfacing to a BLE (e.g., between cellular phones);
   d. a microprocessor-controller: synchronizes events, receives/transmits data and commands, turns modules on or off;
   e. a GPS module, typically used in mobile applications;
   f. flash memory;
   g. connectors;
   h. a plastic enclosure with 2 LED displays (stand-by, transmit);
   i. optionally, a cellular transceiver SIM or a satellite transceiver (2-3 watts)
2. A smart phone application to
   a. Register a clip as a member of the services;
   b. Receive alerts, reminders, instructions; and
   c. Display the status of the network or clip.
3. A cloud server and interface between cloud and clips(s), comprising
   a. a software module to decrypt the incoming clips data packet;
   b. a cloud database & management software;
   c. a software module to manage virus detection;
   d. matrix management software;
   e. an algorithm, in some vehicular mobile implementations, to manage car traffic management as well as traffic lights, automatically;
   f. a software module to manage routing to destination clip;
   g. APIs between the cloud server and government or law-enforcement agencies' terminals, transmitting relevant data to the agency and receiving messages for further transaction handling between agencies terminals as well as pertinent driver(s).

In some embodiments, the network is based on clip units, no matter how many or how few are there, or, where their relative location, distance or density is.

In some embodiments, a clip device connects to sensors/actuators, or digital/analog input/output connected directly to it, or receiving commands or data from a cloud server or other clips

The cloud provides access to individual registered subscribers as well as commands to the platform via the smart phone apps.

In some embodiments, the cloud sorts incoming data from various Wi-Fi's, clips, or cellular modems (stationary or mobile application), or satellite transceivers. A typical data stream from any of these is a combined stream of clip data packets from different premises (usually only in stationary applications) and spaces The hierarchy in stationary embodiments is clips within a premise, typically defined by customer, and premises within a space, typically defined by terrain and wireless propagation. Members may have any number of premises, as per their own definition, or any number of spaces as per wireless propagation and terrain will dictate. Cloud sorting of clips is based on the correlation between the premise ID received by cloud and the premise ID formed upon initial registration of the Generic, via the free smart phone apps In some embodiments, mobile application clips use only a DSSS transceiver for inter-clip communications and BLE for connecting with the local cellular phone.

The cloud server and clips cooperatively implement an algorithm for managing a clip network formation process, including operation and options, automatically.

Input may be fed to a clip by direct wire connection of the clip with a PLC or sensors/actuators

In a vehicular implementation, computing accurate vehicle location using an algorithm for detecting speeding cars, transmitting it directly to the cloud via its mobile phone (while retaining the first read location not processed by algorithm, but part of the buffer which is part of the thread that may be transmitted as well to the cloud via the trailer clip), and the cloud algorithm may resolve and use the accurate car location in determining final location of this specific speeding car (a premise, or a space in mobile applications, is based on threads formed by clips, the process of forming threads is further described herein).

Clips may be fed data from Sensors/Actuators I/O by direct wire connection with a PLC or sensors/actuators.

In mobile applications, clips may be fed and transmit a GPS location reading every fraction of a second

In some embodiments, a clip data packet has the following configuration:

| | Field description | # bytes |
|---|---|---|
| a. | Lead characters | 2 |
| b. | Clip unique ID | 6 |
| c. | Premise ID (for stationary applications) | 6 |
| d. | Location | 3 |
| e. | Sensors status - Output | 2 |
| f. | Actuators - Input | 2 |
| g. | STOP flag | 1 |
| h. | START Flag | 1 |
| i. | Clip ON/OFF | 1 |
| j. | Respond to “FIND Clip” request | 1 |
| k. | Send Clip buffer content (up to 100 bytes) | 1 |
| l. | Serial data packet | 10 |
| m. | Security kernel | 18 |
| n. | Time stamp for each transaction | 4 |
| o. | CRC byte | 2 |

In some embodiments, clips are specially packaged and/or ruggedized.

In some embodiments, parts are enclosed within the packaging that is compartmentalized (for RF isolation of transceivers), isolation of input AC voltage and for convenience (Flash memory), sealed (against humidity), back-up battery, replacement access and ease of replacement. Typically, the power source is AC mains in stationary embodiments and a rechargeable battery and/or solar panel mobile embodiments.

In defining clip buffer size, there is a trade-off between buffer size and periodicity of a communication cycle. A larger buffer size permits transmission of larger quantities of data, but may lengthen the period of communication cycles.

In some embodiments, during manufacture, clips are initiated with a device manufacturing number (e.g., of 6 bytes: 1 byte for a manufacturer's code and 5 bytes for serial number) as part of a clip ID.

It is within the scope of the invention to provide a wireless network for secure transmission of data from transducers to a cloud server, the network comprising
a. a plurality of transducers, disposed in one or more spaces; each the space comprising one or more premises;
b. clips, each the clip in communicative connection with one of the transducers, therein receiving output data of the transducer; each the clip comprising a processor, a non-transitory computer-readable medium (CRM) storing instructions to the processor, and three wireless communication modules:
   i. a short-range transceiver, configured to establish a wireless link with other the clips in a same the premise;
   ii. a mid-range transceiver, configured to establish a wireless link with other the clips in a same the space; and
   iii. a modem;
c. a cloud server, in communicative connection with each the clip through the modem;
wherein the wireless network is configured to implement a secure communication cycle, characterized by
d. each clip in each premise of a space storing in the CRM,
   i. a unique clip ID of the clip;
   ii. a clip sending code of the clip;
   iii. a premise sending code of the premise;
   iv. a data return code of the clip;
   v. a clip prime code of the clip (used for clip to decrypt the next end-of-cycle packet);
   vi. a premise prime code of the premise (used for clip to decrypt the next end-of-cycle packet);
   vii. a unique clip ID of an initiating clip in the premise;
e. formation of threads, wherein the instructions configured for the processors to cause the clips in each the premise of the space, communicating with the short-range transceivers, to form one or more threads by
   i. the initiating clip initiating a thread by selecting a next clip among the clips in the same premise;
   ii. the next clip and each successive clip selecting a next successive clip, until reaching a last clip, whereby the short-range transceiver of the last clip perceives no other the clips in the premise; and
   iii. one or more remaining clips, if any, in the premise, not selected within a timeout period, initiating (in the same fashion as the selected initiating clip above) one or more additional the threads; (a thread can be a single clip)
f. formation of an encrypted thread packet, wherein the clip in each the thread (excluding single-clip threads) in each the premise, communicating by the short-range transceivers, relaying output data of each transducer to the last clip in the thread, by
   i. the initiating clip encrypting a clip packet, the clip packet comprising an output (for sensors; null output for actuators) of the transducer of the initiating clip, the encryption made with the clip sending code of the initiating clip;
   ii. the initiating clip sending the clip packet to the next clip;
   iii. the next clip and each the successive clip in the thread receiving a train of the encrypted clip packet(s), encrypting a next clip packet—the next clip packet comprising the transducer output of the next clip, the encryption made with the clip sending code of the next or successive clip—then append the encrypted next clip packet to the received encrypted packet train and send a next encrypted clip packet train of the encrypted clip packets to a next the successive clip; and
   iv. the last clip forming thereby a thread packet comprising the encrypted clip packets of the clips in the thread;
   v. last clips of each thread encrypting the thread packet, the encryption made with a premise code of the premise;
g. the last clips of each thread, using the mid-range transceivers, selecting a relay clip from among the last clips;
h. formation of a space packet, by
   i. the last clips sending the encrypted thread packets in one or more hops through the mid-range transceivers (a next-hop clip may send data of a previous-hop clip) to the relay clip;
   ii. the relay clip receiving and concatenating the thread packets, thereby forming a space packet;
i. the relay clip, communicating with the modem, sending the space packet to the server;
j. the server configured for processing the space packet, by
   i. receiving the space packet from the relay clip;
   ii. decrypting the thread packets in the space packet, using the premise sending codes of each the premise; and
   iii. decrypting the clip packets in each the retrieved thread packet, using the clip sending codes of each the premise, thereby retrieving the transducer outputs of each the clip in each the premise;
k. the server further configured for processing return inputs to the clips, by
   i. calculating return inputs to each of the transducers, as a function of the transducer outputs from one or more the spaces;
   ii. encrypting each of the return inputs with the data return code of the clip; and
   iii. sending the encrypted return inputs to corresponding clips;
l. the server further configured for processing an end-of-cycle (EOC) packet, by
   i. randomly generating
      1. a next the clip sending code, a next the clip prime code, and a next the data return code for each the clip;
      2. a next the initiating clip ID, a next the premise sending code, and a next the premise prime code; (for use by clips in a next the communication cycle of the wireless network); and
      3. a clip in each premise specified to be an initiating clip in a next the communication cycle;
   ii. forming the end-of-cycle (EOC) packet comprising
      1. for each premise in the space, the next clip sending code, the clip prime code, the next data return code, and the initiating clip ID—encrypted with the premise prime code; and
      2. for each clip in the premise, a next the clip sending code, and the initiating clip ID—encrypted with the clip prime code;
   iii. sending the EOC packet to its respective premise, for distribution to corresponding the clips in the premise; and
m. each the clip is further configured to
   i. receive and decrypt the EOC packet;
   ii. receive and decrypt the transducer data inputs with the clip data return code, and then send the transducer inputs to corresponding transducers; and
   iii. initiate a new the cycle, using the next clip sending code and the next key premise sending code as described.

It is further within the scope of the invention to provide the above wireless network, wherein the timeout period comprises a base period and an additional random interval.

It is further within the scope of the invention to provide any of the above wireless networks, wherein the clip sends a null transponder output if the transponder is an actuator and receives a null transponder input if the transponder is a sensor.

It is further within the scope of the invention to provide any of the above wireless networks, wherein the server is further configured to detect viruses in any of the received space packet, thread packet, clip packet, or any combination thereof.

It is further within the scope of the invention to provide any of the above wireless networks, wherein a remaining clip not perceiving any other the clips forms a single-clip thread.

It is further within the scope of the invention to provide any of the above wireless networks, wherein the next clip and successive clips in the thread are selected using a method selected from: a clip in the premise with a strongest signal strength of the short-range transceiver, listen-before talk (LBT), an advanced frequency hopping (AFH) feature of the short-term transceiver, or any combination thereof.

It is further within the scope of the invention to provide any of the above wireless networks, wherein the relay clip is selected from: the last clip that perceives the most other the clips with its mid-range transceiver, a last clip with a strongest signal strength of its the modem (e.g., to a router in the premises), or any combination thereof.

It is further within the scope of the invention to provide any of the above wireless networks, wherein sending of the thread packet by the last clip to the relay clip is implemented with more than one hop of the mid-range transceivers of the last clips in a premise.

It is further within the scope of the invention to provide the previous wireless network, wherein a receiving the last clip packages and sends its thread packet together with hopped thread packets from a sending the last clip.

It is further within the scope of the invention to provide any of the above wireless networks, wherein a maximum clip membership of a premise is 5-15 clips. (due to timing constraints)

It is further within the scope of the invention to provide the previous wireless network, wherein the maximum clip membership is 10 clips (recommended);

It is further within the scope of the invention to provide any of the above wireless networks, wherein the short-range communication module is a Bluetooth transceiver.

It is further within the scope of the invention to provide any of the above wireless networks, wherein the mid-range communication module is a DSS transceiver.

It is further within the scope of the invention to provide any of the above wireless networks, wherein the modem comprises a WiFi transceiver, a cellular transceiver, a satellite transceiver, or any combination thereof.

It is further within the scope of the invention to provide any of the above wireless networks, wherein the WiFi transceiver is in communication with a router in the premise or a built-in component within the Clip.

It is further within the scope of the invention to provide any of the above wireless networks, further configured to change boundaries of the spaces as a function of signal conditions and terrain between the mid-range transceivers.

It is further within the scope of the invention to provide any of the above wireless networks, wherein the instructions are further configured to implement a registration of a new clip in a premise, in conjunction with a computing device interfacing with the new clip, the instructions and instructions in an application of the computing device configured for
a. a busy flag of the new clip being activated/registered as a new member
b. the computing device and the short-range transceiver of the new clip establishing a connection;
c. the new clip forming a unique clip ID, the unique ID formed from an one or more of a manufacturer clip ID of the new clip, a premise ID, an address of the computing device, a manufacturing date/time of the new clip;
d. the new clip sending the unique clip ID to the server;
e. The initiation/registration of a new clip includes the cloud server, computing device, and new clip executing the following process:
   i. a user of the computing device fills computing device menu and sends filled form together with an initialization code followed by keypad characters on the computing device;
   ii. computing device and new clip exchange data using the short-range transceiver in order to assemble a test packet made of the unique clip ID and 3 the next clip codes and the next premise ID all to be transmitted by the new clip via the ordinary path formation to the cloud;
   iii. cloud acknowledges reception of the test data packet; recognizing it is a test packet and as such the initiation of the new clip is completed.

It is further within the scope of the invention to provide a mobile wireless network 200 for monitoring vehicular traffic, said network 200 comprising
a. a server 225, comprising a server processor and a non-transitory computer-readable medium;
b. a plurality of mobile clips 210, each said mobile clip 210 disposed in a vehicle 206, each said mobile clip 210 in communicative connection with one or more vehicle transponders 205 comprising a GPS receiver a said vehicle 206; the vehicles 206 and mobile clips 205 are disposed in one or more mobile spaces 220; each said mobile clip 210 comprises a processor, a non-transitory computer-readable medium storing instructions to the processor, and two wireless communication modules comprising
   i. a first transceiver 235, configured to establish a wireless link with one or more said first transceivers 235 of other said mobile clips 210 disposed in the same mobile space 220; and
   ii. a second transceiver 240 configured to establish communicative connection with the server 225;
c. the server 225 stores in said server CRM, for each said mobile clip 210, and each said mobile clip 210 in each said mobile space 220 stores in said clip CRM a mobile clip ID of the mobile clip 210, a space ID of said mobile space 220 of said mobile clip 210, and a one-time pad encryption code (OTPEC) comprising
   i. a mobile clip sending code of the mobile clip 210, used for encryption and decryption of data from the vehicle transponders 205; and
   ii. a mobile data return code of the mobile clip 210, used for encryption and decryption of return data from the server 225 to each said mobile clip 210;
wherein the mobile wireless network 200 is configured to implement a secure communication cycle, characterized by
d. the server 225 selects one or more leader clips 210′ from among mobile clips 210 in each said mobile space and
e. the second transceiver 240 of each said leader clip 210′ receives an initialization signal from the server 225;
f. each said leader clip 210′ initializes a mobile thread 223 with other mobile clips 210 in the same space, said mobile thread extending until a trailer clip 210″;
g. the mobile clips 210 in each said mobile thread 223, beginning with the leader clip 210′, encrypt a clip packet comprising a time stamp, clip ID, and data from the vehicle transponders 205 comprising a location, and transfer accumulated encrypted transponder data along the mobile thread 223, until reaching the trailer clip 210″ of the mobile thread 223;
h. each said trailer clip 210″ transmits a thread packet to the server 225, comprising the encrypted transponder data from each mobile clip 210 in the thread;
i. the server 225 is configured to
   i. receive and decrypt the thread packet from each said trailer clip 210″ in each said space 220;
   ii. group the mobile clips 210 into new mobile spaces 220 to be used for a next said communication cycle, as a function of said vehicular transponder data;
   iii. compute return data, if any, to be sent to each said mobile clip 210, as a function of one or more of the vehicular transponder 205 outputs;
   iv. for each mobile clip 210, randomly generating a new OTPEC, to be used by said mobile clips 210 in a next said communication cycle, and encrypting said new OTPEC (using the present clip receiving code);
   v. transmitting an end-of-cycle (EOC) packet comprising said return data, the 385 next OTPEC, and the next space ID of mobile clips in each thread to each said clip; and
j. wherein the clips are further configured to decrypt said EOC packet, process the return data, and store the next OTPEC and next space ID to implement a next communication cycle.

It is further within the scope of the invention to provide the above mobile wireless network, wherein the second transceiver is further configured to establish a wireless link with one or more said second transceivers of other said mobile clips disposed in the same mobile space.

It is further within the scope of the invention to provide any of the above mobile wireless networks, further configured for
a. calculating the minimum wait time at each traffic light for said vehicles at junctions in each said space, said calculating made as a function of vehicle density map on roadways, vehicle speeds, and vehicle locations in said space;
b. determining optimal signaling of traffic lights in said space;
c. communicating said optimal signaling to municipal major controllers or zone controllers; to light up green, amber, red or no light;
d. sharpening each said vehicle's location accuracy by server
   i. if vehicle speed is below a lower speed threshold, continuing to use locations reported during each threaded communication cycle;
   ii. if vehicle speed is above an upper speed threshold,
      1. additionally receiving transmitted location from the mobile clip, employing the second transceiver, transmitted directly to the server; and
      2. computing speed as a function of at least one said directly send location and at least one said locations sent during communication cycles.

It is further within the scope of the invention to provide the previous mobile wireless network, wherein the lower threshold is about 30 kph and the upper speed threshold is about 60 kph.

It is further within the scope of the invention to provide either of the previous two mobile wireless networks, wherein the computing of speed is a function of at least two directly reported locations and an intermediate periodically reported location sent during a communication cycle.

It is further within the scope of the invention to provide any of the above mobile wireless networks, further configured for implementing a carpool application based on the following steps:
a. receiving names and destinations of one or more drivers from driver mobile devices;
b. receiving names and destinations of one or more riders from rider mobile devices;
c. matching and connecting nearest volunteer drivers with riders;
d. receiving volunteer driver selection of the riders he prefers (due to nearness of their pickup locations to the nearness of the driver and rider destinations); and
e. sending confirmation to the rider mobile devices.

It is further within the scope of the invention to provide the previous mobile wireless network, further configured to
a. upon rider pickup, matching locations of rider and driver devices;
b. confirm a number of riders in the vehicle until the driver reaches exits the vehicle;
c. report insufficient number of riders for HOV lane usage (dependent claim: HOV usage detected according to speed of HOV lane and of the driver's vehicle); and
d. report use of mobile phone while driving.

### BRIEF DESCRIPTION OF THE DRAWINGS

FIG. 1 shows a topology of a wireless network according to some embodiments of the invention.

FIG. 2 shows a functional block diagram of a clip in the network, according to some embodiments of the invention.

FIG. 3 shows a topology of a mobile wireless network according to some embodiments of the invention.

FIG. 4 shows a functional block diagram of a mobile clip in the network, according to some embodiments of the invention.

### DETAILED DESCRIPTION OF THE INVENTION

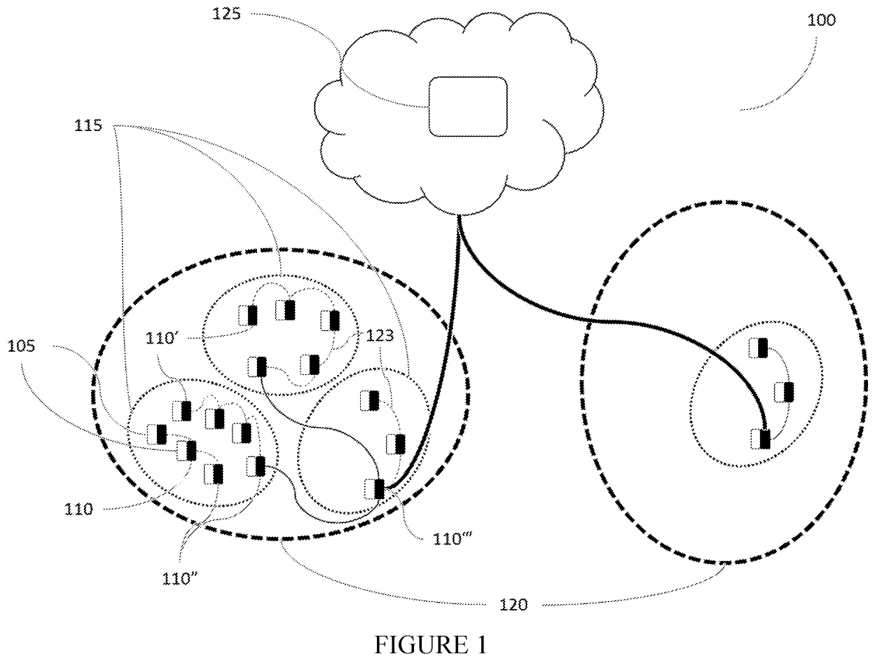

Reference is now made to FIG. 1, showing a topology of a wireless network 100 according to some embodiments of the invention.

Network 100 comprises a plurality of transducers 105. Each transducer 105 can be a sensor or actuator. Transducers 105 can have digital and/or analog inputs and outputs. A transducer can also be a computing device monitoring and/or responding to inputs and conditions in its environment.

Each transducer 105 is communicatively connected to a network communication device called a “clip” 110. Connections between clips 110 and transducers 105 may be implemented using one or more wired or wireless protocols known in the art, such as USB, WiFi, Bluetooth, Ethernet, serial, etc.

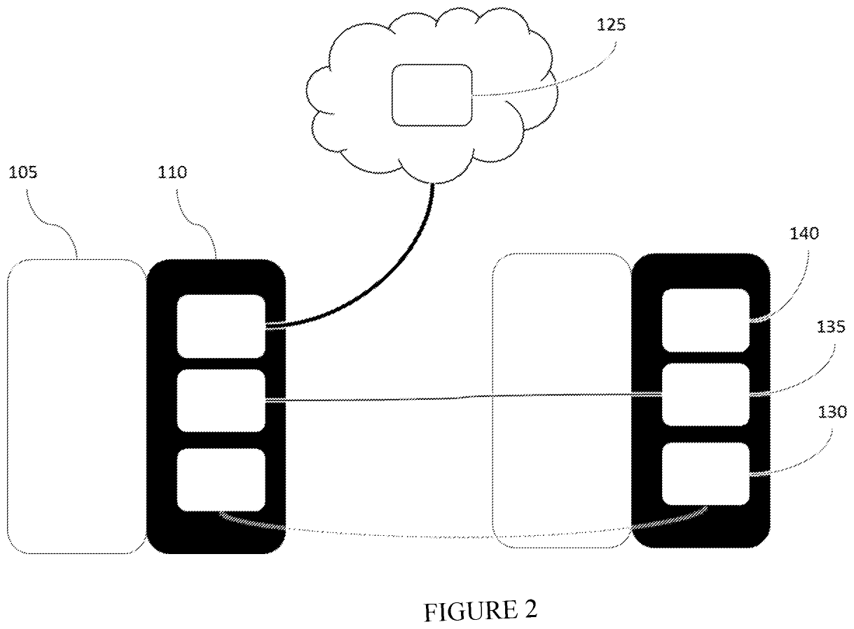

Reference is now also made to FIG. 2, showing a functional block diagram of a clip 110.

In addition to a connection with its transducer 105, each clip is furnished with three wireless network transceivers: a short-range transceiver 130, such as a Bluetooth™ transceiver, which in some implementations has a maximum range of up to about 100 meters; a mid-range transceiver 135, such as a direct-sequence spread spectrum (DSSS) transceiver, which in some implementations has a range of up to about 1.5 kilometers; and a modem 140, such as a WiFi, 460 cellular, or satellite modem. Modem is in communicative connection to a cloud server 125. Each clip 110 further comprises a processor and a non-transitory computer-readable medium, such as non-volatile memory, RAM, magnetic disk, etc.

Reference is now made again to FIG. 1. Clip 110/transducer 105 pairs are located in one or more premises 115. A premise 115 can be a factory, a home, an institution, and the like. For purposes of minimizing a transmission cycle time of network 100, a premise 115 is preferably limited to 5-15 clips 110, most preferably 10 clips. A facility requiring more clips 110 than a designated limit can be divided into several facilities, such as by department or workstation.

One or more premises are located in a space 120. In some embodiments, placement of premises 115 into spaces can vary dynamically according to signal. In some embodiments, one or more spaces is in the domain of a single business entity. In other embodiments, spaces 120 and even premises 115 can be shared by multiple entities, as, for example, a network of clips 110 in a public area.

Clips 110 and server 125 are configured to implement secure communication of data between transponders 105 and server 125. Two-way communication occurs over the course of a communication cycle. For this purpose, during ongoing communication cycles clips 110 store several cryptographic codes:
1. a clip sending code, varying for each clip 110, used by clips 110 to encrypt transponder output data;
2. a premise sending code, varying for each premise 115, used by one or more clips 110 in each premise to encrypt a train of data from each premise;
3. a clip data-return code, varying for each clip 110, used by each clip to decrypt return input data from server 125;
4. a prime clip code, varying for each clip 110, used by each clip to decrypt a set of the above three sending and return codes for a next communication cycle;
5. a prime premise code, varying for each premise, used by one or more clips 110 in each premise to encrypt a train of data from each premise.

All five codes are generated randomly by server 125 and stored in clips 110 for use in a next cycle.

In addition to the cryptographic codes, server 125 also randomly selects a clip 110 in each premise 115 to be an initiating clip 110′. A unique clip ID of initiating clip 110′ is stored on each clip 110 in the premise 115. Every clip also stores its own unique clip ID.

A communication cycle begins with formation threads 123, whereby one or more paths of clips 110 (threads) for relaying outputs of transponders 105 within a premise 115 are established. Clips 110 employ their short-range transceivers 130 during thread formation, for perception and linking of clips 110.

Initiating clip 110′ selects and links to a next clip, from among other clips 110 in premise. The next clip can be selected using any of several criteria known in the art, such as the clip 110 with strongest signal strength, listen-before talk (LBT), an advanced frequency hopping (AFH) feature of said short-term transceiver, or any combination thereof.

Likewise, the next clip and succeeding clips in the thread 123 select a next clip, until reaching a last clip 110″ that perceives no other clips 110 in premise 115. Thread 123 may include all clips in premise 115. However, if a clip 110 in premise 115 is not perceived and linked to thread 123, for example within a time-out period since the end of the previous cycle, it may attempt to initiate a thread. (To avoid possible collisions, the non-perceived clip may wait an additional random interval after the time-out period.) If it perceives no other clips 110 in premise 115, the non-perceived and non-perceiving clip can be a single-clip thread.

After thread formation, clips 110 in each thread 123 encrypt and transmit their data along thread 123, from initiating clip 110′ to last clip 110″. The initiating clip 110′ encrypts a clip packet comprising an output of its transponder 105 (a transponder output is a null output if transponder 105 is an actuator) and sends it the next clip in thread 123. In turn, the next clip and successive clips 110 in thread 123 receive a train of encrypted clip packets, appends its own encrypted clip packet to the train, and then transmits the train to a next successive clip. Last clip 110″ forms a thread packet upon appending its own encrypted clip packet to the train. Last clip 110″ then encrypts the thread packet using the premise encryption code.

With the thread packets of each thread 123 now in a last clip 110″, last clips 110″ in a space 120 employ their mid-range transceivers 135 to select a relay clip relay clip 110″′. The selection process can establish single-hop and/or multi-hops to relay clip 110″′ from other last clips 110″ in space 120. The relay clip 110″′ receives and concatenates encrypted thread packets from other last clips 110″, thereby forming a space packet. The relay clip 110″′, communicating with its modem 140, sends the space packet to the server 125.

The server 125 receives the space packet from relay clip 110″′, and decrypts the thread packets therein, using the premise sending codes of each premise 115. Server 125 then decrypts the clip packets in each decrypted thread packet, using the clip sending codes of each said clip 110, thereby retrieving the transducer outputs of each said clip 110 in each premise 115.

Server 124 calculates return inputs to transponders 105, as a function of the transducer outputs received from one or more spaces 120. This can be implemented, for example, using formulas in a stack of spreadsheets, one spreadsheet for each premise 115 or space 120. The server encrypts the return transponder inputs with the data return code for each clip 110 and sends the encrypted return inputs to the corresponding clips. Clips 110 may each receive their own encrypted return inputs by their modem 140.

Server 125 randomly generates
i. a next said clip sending code, a next said clip prime code, and a next said data return code for each said clip 110;
ii. a next said initiating clip ID, a next said premise sending code, and a next said premise prime code;(for use by clips in a next said communication cycle of said system)
iii. forming an end-of-cycle (EOC) packet comprising
   1. for each premise 115 in said space 120, said next premise sending code, said next initiating clip ID, and said next premise prime code—encrypted with said premise prime code;
   2. for each clip 110 in said premise 115, said next clip sending code and said clip prime code—encrypted with said clip prime code;
iv. sending said EOC packet to its respective premise 115, for distribution to corresponding said clips 110 in said premise 115; and
v. sending said return transducer inputs to corresponding said clips, encrypted using said;
   b. each said clip 110 is further configured to
i. receive and decrypt said EOC packet;
ii. receive and decrypt said transducer data inputs with said clip data return code, and then send said transducer inputs to corresponding transducers 105; and
iii. initiate a new said cycle, using said next short-range encryption and said next mid-range encryption key as described.

Another aspect of the invention relates to the wireless network being further configured to implement a registration of a new clip in a premise. Registration is made in conjunction with a computing device, typically a smart phone, interfacing with a new clip. Software applications on the computing device, the clip, and the server are configured for
a. a busy flag of the new clip being activated/registered as a new member.
b. the computing device and the short-range transceiver of the new clip establishing a connection.
c. the new clip forming a unique clip ID, the unique ID formed from an one or more of a manufacturer clip ID of the new clip (embedded in the clip during manufacture of the clip, containing the manufacturer's own code and the manufacturer's serial number sequencing of clips), a premise ID, an address of the computing device, a manufacturing date/time of the new clip, and a GPS reading of said clip.
d. the new clip sending the clip ID to the cloud server.

The initiation/registration of a new clip further includes the cloud server, computing device, and new clip executing the following process:
e. a user of the computing device sends a filled form together with an initialization code followed by user-depressed keypad characters on the computing device.
   i. the computing device and new clip exchange data, typically using the clip's short-range transceiver, in order to assemble a test packet made of said unique clip ID and three next clip codes and the next premise ID, all to be transmitted by the new clip via the ordinary path formation (further described herein) to the cloud.
   ii. the cloud server acknowledges reception of the test data packet; recognizing it is a test packet and as such the initiation of the new clip is completed.

### Transducer Dependency Map and Connectivity Matrix

Another aspect of the invention relates to a calculation module of the server. The calculation module is configured to:
a. maintain a connectivity map comprising user-specified dependency connections between transducers and conditions of the outputs for computing the return inputs. For example, the user may specify a connection between a sensor and an actuator, and that if the sensor clip records a sensor level exceeding level X, then the actuator clip is to be notified to turn off the actuator.
b. convert the connectivity map into a matrix expressing the relationships between the transducer outputs and the return inputs. The matrix contains one element for each clip.
c. for each destination clip, extracting conditions needed to determine each of the return inputs. Typically, this entails evaluating a function of outputs of sensor clips, to be applied to return inputs of actuator clips.
d. repeating above steps b and c in each communication cycle.

Another aspect of the invention relates to a mobile wireless network for monitoring vehicular traffic. The system has potential applications, further described herein, for controlling traffic, for arranging carpools, and for reporting traffic violations.

While the mobile aspect invention is described in reference to a vehicle, it is understood that the features are also applicable to non-vehicular applications, such as pedestrians or livestock.

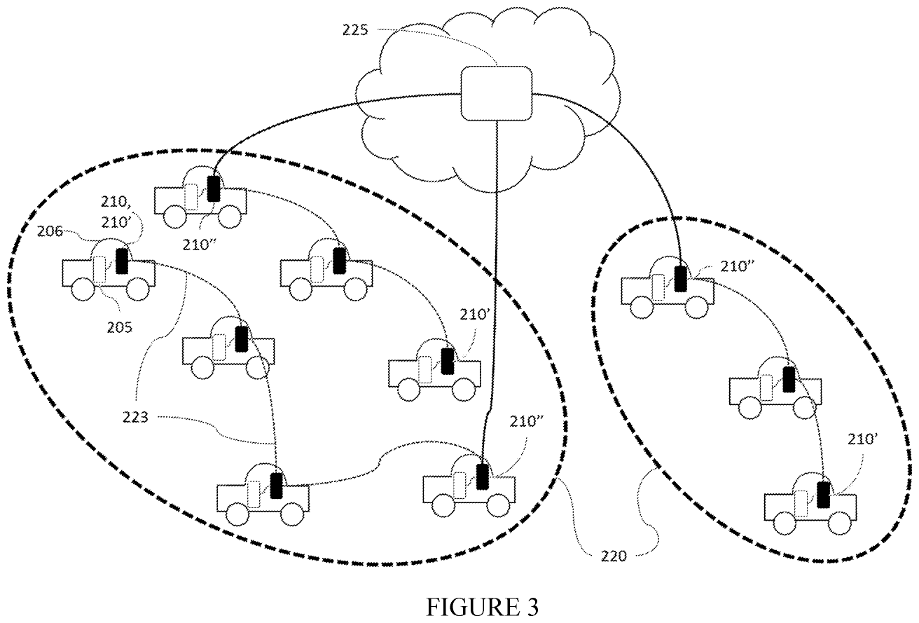

Reference is now made to FIG. 3, showing a mobile wireless network 200 for monitoring vehicular traffic. The network 200 comprises a server 225, typically a cloud server, and a plurality of mobile clips 210. Each mobile clip 210 is disposed in a vehicle 206 and in communicative connection with one or more vehicle transponders 205.

Vehicle transponders 205 can include a GPS receiver. A vehicle transponder 205 may comprise a mobile phone or other mobile device disposed with the driver of a vehicle 206, which can report GPS coordinates of the vehicle 206. Alternatively, or in addition, a mobile device may act as a mobile clip 210, with communication capability of at least one type of the clip transceivers further described herein. Alternatively, or in addition, a mobile device may be in communicative connection with a transponder of the vehicle, such as by a Bluetooth, WiFi, or USB link.

Vehicles 206, with their transponders 205 and mobile clips 210, are disposed in one or more mobile spaces 220. Allotment of vehicles into mobile spaces 220 is periodically computed by server 225 based on transponder data, as further described herein.

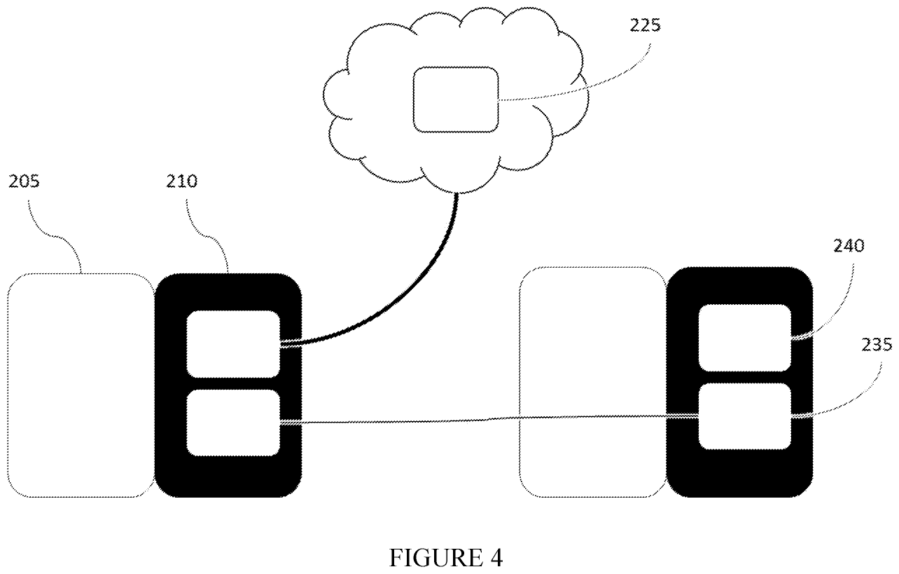

Reference is now made to FIG. 4, showing details of mobile clips 210. Each mobile clip 210 is equipped with two wireless transceivers: a first transceiver 235 and a second transceiver 240. First transceiver 235 is enabled to establish direct wireless links and communicate with at least some of the other mobile clips 210 disposed in the same mobile space 220. First transceiver ideally has communication a range of up to about 1.2-1.5 kilometers, although a shorter range is suitable for some embodiments. First transceiver 235 can be a direct-sequence spread spectrum (DSSS) transceiver.

Second transceiver 240 is enabled to establish connection and communicate with server 225. Second transceiver 240 may comprise one or more of a cellular modem, a satellite modem, and a wireless transceiver (e.g., WiFi) for communication through a municipal wireless network, where available. In some embodiments, second transceiver 240 may be enabled to communicate with another mobile clip's second transceiver. For example, a mobile clip 210 makes a selection to employ either its first transceiver 235 or second transceiver 240, whichever has superior signal quality with other mobile clips 210 in the mobile space 220.

In some embodiments, first transceiver 235 may communicate with server 225; for example, when a vehicle 206 is close enough to an access point of server 225.

Each mobile clip 210 stores its own mobile clip ID. Additionally, each mobile clip 210 stores a one-time pad encryption code (OTPEC) and a space ID of an assigned mobile space 220. Server 225 creates and distributes OTPECs and space IDs to mobile clips 210, as further described herein. The OTPEC comprises
a. a clip sending code of the mobile clip 210, used for encryption by the mobile clip 210 and decryption by server 225 of data from the vehicle transponders 205;
b. a clip receiving code of the mobile clip 210, used for encryption by server 210 and decryption by mobile clip 210 of return data to mobile clip 210 generated by server 225.

Server 225 and mobile clips 210 implement a periodic secure communication cycle. For each mobile space 220, server 225 selects one or more leader clips 210′ from among mobile clips 210 in the mobile space 220. Selection may be made randomly or as a function of signal strengths of second transceivers 240 reported by mobile clips 210 in a mobile space 220. Additionally (or alternatively), selection may be made as a function of geographic locations of mobile clips 210, proximities to other mobile clips 210, and/or reported signal strengths of first transceivers 235 to first transceivers 235 of other mobile clips 210.

Each leader clip 210′ receives an initialization signal from the server 225. The leader clip 210′ initializes a mobile thread 223 with other mobile clips 210 in the same mobile space 220. In some embodiments, a thread may include mobile clips 210 in adjacent mobile spaces 220. Formation of the mobile thread 223 extends until reaching a trail clip 210″.

In some embodiments, thread formation may be computed, using any means known in the art, by mobile clips 210 and/or server 225. In some embodiments of network 200, steps of thread formation, in whole or in part, are analogous to those employed in embodiments of network 100. (In such embodiments, first transceiver 235 and second transceiver 240 of network 200 function, in relation to network topography, as do short-range transceiver 130 and modem 140, respectively, of network 100).

Mobile clips 210 in each mobile thread 223 encrypt a clip packet comprising data from the vehicle transponders 205. The data may further comprise signal strengths of second transceiver 240 with an access point to server 220 and/or signal strengths and clip IDs of first transceiver 235 and/or second transceiver 240 to specified other mobile clips 210. The clip packet further comprises the clip ID of mobile clip, which may or may not be encrypted. The clip packet may further comprise a time stamp.

Beginning with the leader clip 210′, mobile clips 210 transfer clip packets along the mobile thread 223. Each successive mobile clip 210 in mobile thread 223 accumulates the received transferred encrypted data packets, adds its own, and passes the chain of encrypted clip packets on to the next mobile clip 210 in the mobile thread 223. The trailer clip 210″ of each mobile thread 223 forms a thread packet, comprising a collection of encrypted clip packets of mobile clips 210 in the mobile thread 223. Trailer clip 210″ of each mobile thread 223 transmits the thread packet to the server 225. After receiving a thread packet from a trailer clip 210″, server 225 decrypts the thread packet to determine clip ID and vehicular transponder data of mobile clips 210 in thread 123.

Server 225 computes new groupings of mobile clips 210 into mobile spaces 220, to be used for the next communication cycle, as a function of received transponder data from single mobile clips 210 and and/or from an aggregation some or all mobile clips 210 in the same mobile thread 223, in the same mobile space 220, and/or in multiple global spaces 220. The computation may be made using algorithms known to a person of skill in the art.

For each mobile clip 210, server 225 randomly generates a new OTPEC, which mobile clip 210 will use in a next communication cycle.

In some embodiments, server 225 also computes return data to one or more mobile clips 210, such as traffic alerts or traffic commands.

Server creates an end-of-cycle (EOC) packet for each mobile clip 210, comprising the space ID of the newly assigned mobile space of the mobile clip 210, the return data to the mobile clip 210, if any, and the new OTPEC—encrypted with the present (not the next) clip receiving code of the mobile clip 210. The space ID and/or return data may or may not be also encrypted.

For each mobile thread 223, server 225 bundles the EOC packets of each mobile clip 210 in the mobile thread 223 for transmission to each mobile clip 210. Server 225 may transmit EOC packets to each mobile clip 210 via their second transceivers. Each mobile clip 210 and transducers 205 attached thereto process the return data. Each clip stores the updated OTPEC and space ID for a next communication cycle.

Communication cycles may be periodic or may vary depending on traffic density (e.g., the communication cycle may be lengthened if there are a large number of mobile clips 210 in a mobile thread 223. Communication cycle periods may be staggered, to allow for processing fewer mobile clips 210 each time but with more granularly updated traffic calculations.

In some embodiments, server 225 may be further configured for optimizing traffic light control.

Server 225 calculates how to minimize the wait time at each traffic light for vehicles 206 at junctions disposed in mobile spaces 220, as a function of vehicle density map on roadways, vehicle speeds, and vehicle locations in mobile spaces 220. Server 225 determines the optimal signaling of traffic lights in the spaces 220. Server 225 communicates the optimal signaling to municipal major controllers or zone controllers; for example, to light up green, amber, or red. In some embodiments, server 225 may communicate no light at all (for example, if a traffic police computer reports to server 220 that traffic at the intersection is being directed by an officer).

In some embodiments, network 200 employs an algorithm for improving accuracy of location of vehicles 206.

The speed of a vehicle 206 may be computed from a plurality of GPS readings. The computation may be made by the mobile clip 205 of the vehicle 260. If the speed of a vehicle 206 is below a lower speed threshold, preferably about 30 kph, server 225 continues to compute the vehicle speed using transmitted locations reported by the GPS receiver regularly during each periodic threaded communication cycle. If the vehicle 206 is travelling above an upper speed threshold, preferably about 60 kph, the mobile clip 210 in the vehicle 206 time stamps and reports the GPS receiver coordinates directly to server 225, employing its second transceiver 240. From the two timestamps of at least the two locations, one directly reported the other regularly reported, or both directly reported; or three timestamps of two directly reported locations and one intermediate periodic location, server 225 can calculate the present speed and location of the vehicle 206, more accurately than possible using fewer data points.

In some embodiments, network 200 is further configured to provide or support arrangement of carpooling.

Server 225 receives, from mobile devices of drivers, names and destinations of the drivers. A driver mobile device may be a mobile device used in connection with mobile clip 210 or vehicle transponder 205 of the driver's vehicle 206. Alternatively, a driver mobile device may be a separate mobile device. In either case, the driver mobile device is associated with the clip ID of the vehicle's mobile clip 205 while the vehicle 206 is connected to network 200. In some 720 embodiments, driver may specify a departure time of a planned trip.

Additionally, server 225 receives names, pickup locations, and requested destinations of riders from rider mobile devices. Pickup location may be received from a GPS receiver of the rider mobile device, if the rider is presently ready to be picked up. In some embodiments, the rider may specify a pickup time, if the ride is for a later time. In some embodiments, the rider is or will be driving a vehicle and willing to park at a nearby or on-the-way daily lot as the pickup location.

Server 225 associates the requested destinations with matching driver destinations, and communicates the requested destination and pickup locations of the matches to the appropriate driver mobile device, which displays the rider name, requested destinations, pickup locations, and, pickup time if applicable.

The driver may select one or more of the matched riders, according to the driver's preference, for example due to convenience of pickup location and time and/or nearness of driver and rider destinations. In some embodiments, server 225 may compute best-matched ride requests according to the pickup locations and times and rider destination, compared with the driver's departure time, departure location, and destination. The driver mobile device receives the matched ride requests and displays them preferentially or as suggested rides.

Server 225 receives a selection from the driver mobile device and sends the driver's acceptance to the appropriate rider mobile device. Server 225 receives an accepted offer from the rider mobile device and transmits the rider's acceptance to the driver mobile device. Server 225 registers the carpool ride and associates the carpool ride with the relevant data (e.g., IDs of driver and rider mobile devices, clip ID, pickup location, expected pickup time, and/or destination, etc.).

In some embodiments, server 225 detects pickup of the rider by detecting simultaneously matching GPS locations reported by the mobile clip 205 and by the rider mobile device, at or near the expected time and place of pickup. Server 225 may detect multiple rider mobile devices of registered carpool rides in the same vehicle 205. Server 225 monitors the number of riders in the vehicle 206. When server 225 detects a drop off by arrival and stopping of vehicle at a rider destination, server decrements the number of riders.

In some embodiments, server 225 monitors the speed of the carpool vehicle 206. If the speed and location are consistent with travel on a high-occupancy lane (e.g., server 225 detects that most vehicles 206 at the same point along the highway are travelling at a slower speed), server then checks the number of riders. If the driver and number of riders is less than passengers allowed for the HOV, server alerts a computer of a traffic enforcement authority, which can register a summons of the offending driver for a traffic violation. In some embodiments, server 225 reports if the vehicle is above the speed limit for the highway.

In some embodiments, server 225 monitors use of driver mobile device, such as use of applications thereon for telephoning or text messaging. Server 225 may alert a traffic enforcement computer that the driver is using his mobile device while driving. In some embodiments, the same application used for carpooling reports the violation to server 225. In other embodiments, the server 225, possibly in cooperation with providers of online mobile application services, monitors the driver's online account for accountholder activity on one or more online services.

A method for secure transmission and processing of data between transducers and a cloud server, according to some embodiments of the invention, acquiring a wireless network of the invention;
a. disposing a plurality clips in one or more premises of one or more spaces, each clip in connection with one or more transducers;
b. receiving outputs of the transducers by each clip in connection therewith;
c. encrypting the outputs by each of the clips using a clip sending code of the clip;
d. forming threads in each premise of each space, by the clips;
e. forming a thread packet, comprising the encrypted outputs, along each the thread;
f. encrypting the thread packet by a last clip in each thread using a premise sending code of the premise;
g. selecting a relay clip among the last clips of each thread in each space;
h. forming a space packet, among the last clips of each thread in each space, at the relay clip of each space;
i. communicating the space packet to the cloud server, by each relay clip;
j. calculating return inputs to transducers connected to each clip, by the cloud server;
k. encrypting the return inputs with a data return code of each clip;
l. sending the encrypted return inputs to the corresponding clips;
m. randomly generating, for a next communication cycle, a next clip sending code, a next clip prime code, and a next clip data return code for each clip;
n. randomly generating, for a next communication cycle, a next premise sending code and next premise prime code;
o. randomly determining an initiating clip in each premise for the next cycle;
p. forming and sending an end-of-cycle (EOC) packet comprising for each premise, the next clip sending code, the next clip prime code, the next data return code, and the initiating clip ID—encrypted with the present premise prime code; and for each clip in the premise, the next clip sending code the initiating clip ID—encrypted with the present clip prime code;
q. sending the EOC packet to its respective premise, for distribution to corresponding said clips in the premise;
r. receiving and decrypting the EOC packet, by each clip;
s. receiving and decrypting the transducer data inputs with the present clip data return code, and then sending the transducer inputs to the corresponding transducers.

A method for secure transmission and processing of data between vehicular transducers and a cloud server, according to some embodiments of the invention, comprising steps of
a. acquiring a mobile wireless network of the invention;
b. disposing a plurality vehicles with mobile clips in one or more spaces, each clip in connection with one or more transducers comprising a GPS receiver;
c. selecting a leader clip from among mobile clips in each space;
d. receiving an initialization signal from a cloud server, by each leading clip;
e. initializing a mobile thread with other mobile clips in the same space, by each leading clip, the mobile thread extending until a trail clip;
f. encrypting a clip packet comprising a time stamp, clip ID, and data from the vehicle transponders comprising a location, by each clip in the thread;
g. transferring encrypted clip packets along the thread, until reaching the trailer clip;
h. sending the thread packet to a cloud server;
i. receiving and decrypting the thread packet from each said trailer clip in each space;
j. computing groupings of the mobile clips into new mobile spaces to be used for a next communication cycle, as a function of said vehicular transponder data;
k. computing return data, if any, to be sent to each said mobile clip, as a function of one or more of the vehicular transponder outputs;
l. randomly generating a new OTPEC, for each mobile clip, to be used by the mobile clips in a next said communication cycle, and encrypting the new OTPEC using the present clip receiving code of each clip;
m. transmitting an end-of-cycle (EOC) packet comprising the return data, the next OTPEC, and the next space ID of each mobile clip in each thread to each trailer clip; and
n. receiving the EOC packet, by each trailer clip employing, for distribution along the thread, of the return data, and the OTPEC to each clip in the mobile thread.

1. A wireless network 100 for secure transmission of data from transducers to a cloud server, said network 100 comprising:
a. a plurality of transducers 105, disposed in one or more spaces 120; each said space 120 comprising one or more premises 115;
b. clips 110, each said clip 110 in communicative connection with one of said transducers 105, therein receiving output data of said transducer 105; each said clip 110 comprising a processor, a non-transitory computer-readable medium (CRM) storing instructions to said processor, and three wireless communication modules:
i. a short-range transceiver 130, configured to establish a wireless link with other said clips 110 in a same said premise 115;
ii. a mid-range transceiver 135, configured to establish a wireless link with other said clips 110 in a same said space 120; and
iii. a modem 140;
c. a cloud server 125, in communicative connection with each said clip through said modem;
wherein said wireless network 100 is configured to implement a secure communication cycle, characterized by
d. each said clip 110 in each said premise 115 of a said space 120 storing in said CRM
i. a unique clip ID of said clip 110;
ii. a clip sending code of said clip 110;
iii. a premise sending code of said premise 115;
iv. a data return code of said clip 110;
v. a clip prime code of said clip 110 (used for clip to decrypt the next end-of-cycle packet);
vi. a premise prime code of said premise 115 (used for clip to decrypt the next end-of-cycle packet);
vii. a said unique clip ID of an initiating clip 110′ in said premise 115;
e. formation of threads, wherein said instructions configured for said processors to cause said clips 110 in each said premise 115 of said space 120, communicating with said short-range transceivers 130, to form one or more threads 123 by
i. said initiating clip 110′ initiating a said thread 123 by selecting a next clip among said clips 110 in a said same premise 115;
ii. said next clip and each successive clip selecting a next successive clip, until reaching a last clip 110″, whereby said short-range transceiver 130 of said last clip 110″ perceives no other said clips 110 in said premise 115; and
iii. one or more remaining clips, if any, in said premise 115, not selected within a timeout period, initiating (in the same fashion as the selected initiating clip above) one or more additional said threads 123; (a thread can be a single clip)
f. formation of an encrypted thread packet, wherein said clip 110 in each said thread 123 (excluding single-clip threads) in each said premise 115, communicating by said short-range transceivers 130, relaying output data of said each said transducer to said last clip 110″ in said thread 123, by
i. said initiating clip 110′ encrypting a clip packet, said clip packet comprising an output (for sensors; null output for actuators) of said transducer 105 of said initiating clip 110′, said encryption made with said clip sending code of said initiating clip 110′;
ii. said initiating clip 110′ sending said clip packet to said next clip;
iii. said next clip and each said successive clip in said thread 123 receiving a train of said encrypted clip packet(s), encrypting a next clip packet—said next clip packet comprising said transducer output of said next clip, said encryption made with a said clip sending code of said next or successive clip—then append said encrypted next clip packet to said received encrypted packet train and send a next encrypted clip packet train of said encrypted clip packets to a next said successive clip; and
iv. said last clip 110″ forming thereby a thread packet comprising said encrypted clip packets of said clips 110 in said thread 123;
v. last clips 110″ of each thread 123 encrypting said thread packet, said encryption made with a premise code of said premise 115;
g. said last clips of each thread 110″, using said mid-range transceivers 135, selecting a relay clip 110″′ from among said last clips 110″;
h. formation of a space packet, by
i. said last clips 110″ sending said encrypted thread packets in one or more hops through said mid-range transceivers 135 (a next-hop clip may send data of a previous-hop clip) to said relay clip 110″′;
ii. said relay clip 110″′ receiving and concatenating said thread packets, thereby forming a space packet;
i. said relay clip 110″′, communicating with said modem 140, sending said space packet to said server 125;
j. said server 125 configured for processing said space packet, by
i. receiving said space packet from said relay clip 110″′;
ii. decrypting said thread packets in said space packet, using said premise sending codes of each said premise 115; and
iii. decrypting said clip packets in each said retrieved thread packet, using said clip sending codes of each said premise 115, thereby retrieving said transducer outputs of each said clip 110 in each said premise 115;
k. said server 125 further configured for processing return inputs to said clips 110, by
i. calculating return inputs to each of said transducers 105, as a function of said transducer outputs from one or more said spaces 120;
ii. encrypting each of said return inputs with said data return code of said clip 110; and
iii. sending said encrypted return inputs to corresponding clips;
l. said server 125 further configured for processing an end-of-cycle (EOC) packet, by
i. randomly generating
1) a next said clip sending code, a next said clip prime code, and a next said data return code for each said clip 110;
2) a next said initiating clip ID, a next said premise sending code, and a next said premise prime code; (for use by clips in a next said communication cycle of said wireless network); and
3) a clip 110 in each premise 115 specified to be a said initiating clip 110 in a next said communication cycle;
ii. forming said end-of-cycle (EOC) packet comprising
1) for each premise 115 in said space 120, said next clip sending code, said clip prime code, said next data return code, and said initiating clip ID—encrypted with said premise prime code; and
2) for each clip 110 in said premise 115, a next said clip sending code, and said initiating clip ID—encrypted with said clip prime code;
iii. sending said EOC packet to its respective premise 115, for distribution to corresponding said clips 110 in said premise 115; and
m. each said clip 110 is further configured to
i. receive and decrypt said EOC packet;
ii. receive and decrypt said transducer data inputs with said clip data return code, and then send said transducer inputs to corresponding transducers 105; and
iii. initiate a new said cycle, using said next clip sending code and said next key premise sending code as described.

2. The wireless network of claim 1, wherein said timeout period comprises a base period and an additional random interval.

3. The wireless network of claim 1, wherein said clip sends a null transponder output if said transponder is an actuator and receives a null transponder input if said transponder is a sensor.

4. The wireless network of claim 1, wherein said server is further configured to detect viruses in any of said received space packet, thread packet, clip packet, or any combination thereof.

5. The wireless network of claim 1, wherein a said remaining clip not perceiving any other said clips forms a single-clip thread.

6. The wireless network of claim 1, wherein said next clip and successive clips in a said thread are selected using a method selected from: a clip in said premise with a strongest signal strength of said short-range transceiver, listen-before talk (LBT), an advanced frequency hopping (AFH) feature of said short-term transceiver, or any combination thereof.

7. The wireless network of claim 1, wherein a said relay clip is selected from: a said last clip that perceives the most other said clips with its mid-range transceiver, a said last clip with a strongest signal strength of its said modem (e.g., to a router in the premises), or any combination thereof.

8. The wireless network of claim 1, wherein sending of said thread packet by a said last clip to said relay clip is implemented with more than one hop of said mid-range transceivers of said last clips in a premise.

9. The wireless network of claim 8, wherein a receiving said last clip packages and sends its thread packet together with hopped thread packets from a sending said last clip.

10. The wireless network of claim 1, wherein a maximum clip membership of a said premise is 5-15 clips (due to timing constraints).

11. The wireless network of claim 9, wherein said maximum clip membership is 10 clips (recommended).

12. The wireless network of claim 1, wherein said short-range communication module is a Bluetooth transceiver.

13. The wireless network of claim 1, wherein said mid-range communication module is a DSS transceiver.

14. The wireless network of claim 1, wherein said modem comprises a WiFi transceiver, a cellular transceiver, a satellite transceiver, or any combination thereof.

15. The wireless network of claim 1, wherein said WiFi transceiver is in communication with a router in said premise or a built-in component within the said Clip.

16. The wireless network of claim 1, further configured to change boundaries of said spaces as a function of signal conditions and terrain between said mid-range transceivers.

17. The wireless network of claim 1, wherein said instructions are further configured for a said processor to implement a registration of a new clip in a said premise, in conjunction with a computing device interfacing with said new clip, said instructions and instructions in an application of said computing device configured for
f. a busy flag of said new clip being activated/registered as a new member
g. said computing device and said short-range transceiver of said new clip establishing a connection;
h. said new clip forming a unique clip ID, said unique ID formed from an one or more of a manufacturer clip ID of said new clip, a said premise ID, an address of said computing device, a manufacturing date/time of said new clip;
i. said new clip sending said unique clip ID to said server;
j. The initiation/registration of a new clip includes said cloud server, computing device, and new clip executing the following process:
iii. a user of said computing device fills computing device menu and sends filled form together with an initialization code followed by keypad characters on said computing device;
iv. computing device and new clip exchange data using said short-range transceiver in order to assemble a test packet made of said unique clip ID and 3 said next clip codes and said next premise ID all to be transmitted by the new clip via the ordinary path formation to the cloud;
v. cloud acknowledges reception of the test data packet; recognizing it is a test packet and as such the initiation of the new clip is completed.
